(19) United States
(12) Patent Application Publication
(10) Pub. No.: US 2011/0220246 A1
(43) Pub. Date: Sep. 15, 2011

(54) METHOD OF MANUFACTURING COMPRESSED WOOD PRODUCT

(75) Inventors: Tatsuya SUZUKI, Tokyo (JP); Yuko NAKAJIMA, Tokyo (JP)

(73) Assignee: OLYMPUS CORPORATION, Tokyo (JP)

(21) Appl. No.: 13/036,692

(22) Filed: Feb. 28, 2011

(30) Foreign Application Priority Data
Mar. 11, 2010 (JP) 2010-055018

(51) Int. Cl. B27M 1/02

(52) U.S. Cl. 144/380

(57) ABSTRACT

A method of manufacturing a compressed wood product includes applying a compressive force to a wooden piece in a water-vapor atmosphere having temperature and pressure higher than those of atmospheric air to deform the wooden piece into a three-dimensional shape having a curved surface; placing an attachment for forming a pattern at a desired position on a surface of the wooden piece after applying the compressive force; and applying a pressure to the attachment and the wooden piece while heating the attachment and the wooden piece in the atmospheric air to shape the wooden piece into substantially the same shape as the three-dimensional shape and to firmly fix the attachment to the wooden piece.

### CROSS-REFERENCE TO RELATED APPLICATION

This application is based upon and claims the benefit of priority from Japanese Patent Application No. 2010-55018, filed on Mar. 11, 2010, the entire contents of which are incorporated herein by reference.

### BACKGROUND OF THE INVENTION

1. Field of the Invention

The present invention relates to a method of manufacturing a compressed wood product having a predetermined three-dimensional shape by compressing and forming a wooden piece.

2. Description of the Related Art

In recent years, wood which is a natural material attracts attention. With a wide variety of grain patterns, wood products exhibit individual features depending on positions of raw wood from which the particular wood products are cut out. In addition, surface flaws and discolorations caused by a long-term use create unique textures which tend to evoke warm and familiar feeling in the user. Thus, the wood attracts attention as a material for products of uniqueness and taste which cannot be found in products made of synthetic resin or light metals. Techniques for processing wood are also developing dramatically.

According to one conventionally known technique for processing a wooden piece into a predetermined three-dimensional shape by compressing the wooden piece, a wooden board, which has been softened in a water vapor atmosphere of a temperature and a pressure higher than those of an atmospheric air, is processed into a predetermined three-dimensional shape by compressing the wooden board (see, for example, Japanese Patent Application Laid-Open No. H11-77619).

### SUMMARY OF THE INVENTION

A method of manufacturing a compressed wood product according to an aspect of the present invention includes applying a compressive force to a wooden piece in a water-vapor atmosphere having temperature and pressure higher than those of atmospheric air to deform the wooden piece into a three-dimensional shape having a curved surface; placing an attachment for forming a pattern at a desired position on a surface of the wooden piece after applying the compressive force; and applying a pressure to the attachment and the wooden piece while heating the attachment and the wooden piece in the atmospheric air to shape the wooden piece into substantially the same shape as the three-dimensional shape and to firmly fix the attachment to the wooden piece.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a flowchart illustrating the brief of a method of manufacturing a compressed wood product according to an embodiment of the present invention;

FIG. 2 is a diagram typically illustrating the brief of a cutting-out process in the method according to the embodiment;

FIG. 3 is a perspective diagram typically illustrating the brief of a compression process in the method according to the embodiment;

FIG. 4 is an A-A line cross-sectional view of FIG. 3;

FIG. 5 is a cross-sectional view in a state where three-dimensional deformation of a blank piece has been substantially completed at the compression process in the method according to the embodiment;

FIG. 6 is a perspective diagram illustrating the blank piece on which a drying process has been completed in the method according to the embodiment;

FIG. 7 is a cross-sectional view typically illustrating the brief of a fixing process in the method according to the embodiment;

FIG. 8 is a cross-sectional view typically illustrating a state where a pair of heating concave metal mold and heating convex metal mold is fastened at the fixing process in the method according to the embodiment;

FIG. 9 is a cross-sectional view illustrating a state where paper is firmly fixed to the blank piece and then the blank piece is cut at the position of the paper;

FIG. 10 is a perspective diagram illustrating a manufactured compressed wood product;

FIG. 11 is a perspective diagram illustrating an exterior body of a digital camera as an example of application of the compressed wood product manufactured by the method according to the embodiment; and

FIG. 12 is a perspective diagram illustrating a digital camera having the exterior body illustrated in FIG. 11 as a jacket.

### DETAILED DESCRIPTION OF THE PREFERRED EMBODIMENTS

A method of manufacturing a compressed wood product according to an embodiment of the present invention will be explained in detail below with reference to the accompanying drawings. However, the present invention is not limited to the embodiment.

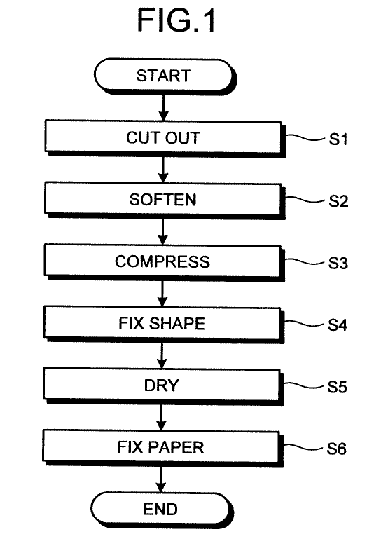

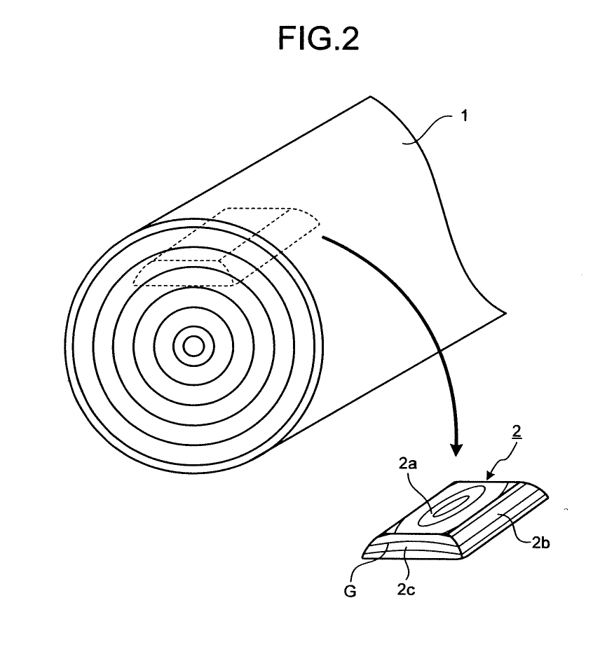

FIG. 1 is a flowchart illustrating the brief of a method of manufacturing a compressed wood product according to an embodiment of the present invention. First, the form of a blank piece that has a shape substantially like a bowl is cut out from raw wood (Step S1). FIG. 2 is a diagram typically illustrating the brief of a cutting-out process. In the cutting-out process, the form of a blank piece 2 that has a shape substantially like a bowl is taken by cutting or the like from raw wood 1 such as uncompressed solid wood.

The blank piece 2 includes a main plate portion 2a that has a flat plate-shaped and a substantially rectangular surface, two side plate portions 2b that curve and extend from each of two facing long sides to the main plate portion 2a on the surface of the main plate portion 2a, and two side plate portions 2c that curve and extend from each of two facing short sides to the main plate portion 2a on the surface of the main plate portion 2a. FIG. 2 shows the main plate portion 2a which is a flat-grain piece whose grain pattern G is substantially parallel to a fiber direction of the blank piece 2. However, the blank piece which is taken at the cutting-out process can be a straight-grain piece or an end-grain piece. Moreover, the shape of the blank piece 2 is only an example. In other words, the term “a shape substantially like a bowl” includes a dish shape, a box shape, and the like in addition to the shape of the bowl.

Next, the blank piece 2 cut out is left for a predetermined time in a water-vapor atmosphere having high temperature and pressure to soften the blank piece 2 (Step S2). In the water-vapor atmosphere, a pressure is around 0.1 to 0.8 MPa and a temperature is around 100 to 170° C. The water-vapor atmosphere is realized by using a pressure vessel. When using a pressure vessel, it is only necessary that the blank piece 2 is softened while left in the pressure vessel having the water-vapor atmosphere. Moreover, instead of softening the blank piece 2 in the water-vapor atmosphere having high temperature and pressure, the blank piece 2 may be softened by heating with a microwave. Moreover, the blank piece 2 may be softened by boiling.

After that, the softened blank piece 2 is compressed (Step S3). At the compression process, the blank piece 2 is sandwiched by a pair of metal molds in the same water-vapor atmosphere as that at the softening process, and the blank piece 2 is deformed by applying a compressive force in the shape substantially like a bowl different from the shape before the softening process. When the blank piece 2 is softened in the pressure vessel, it is only necessary to continuously compress the blank piece 2 in the pressure vessel.

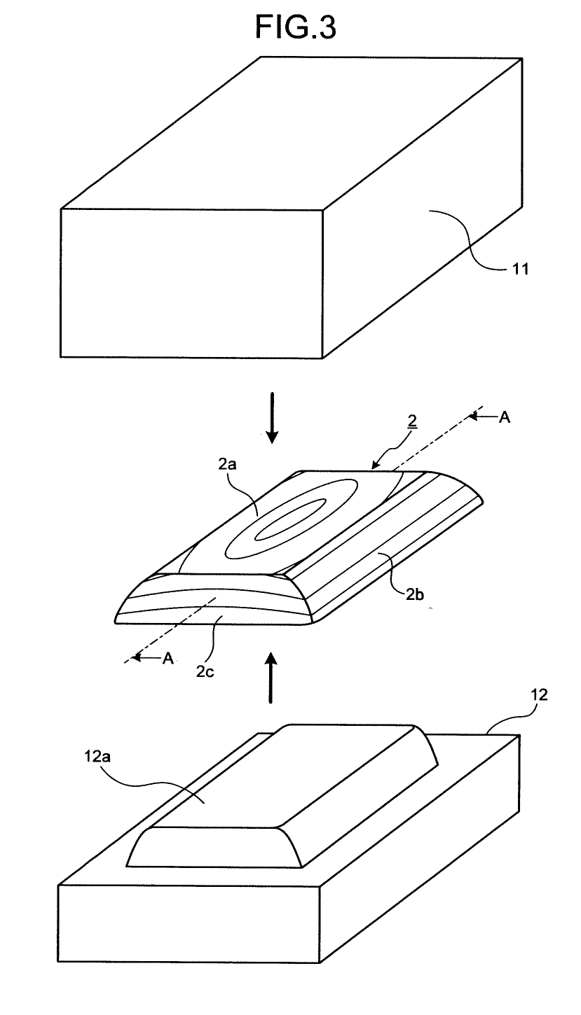

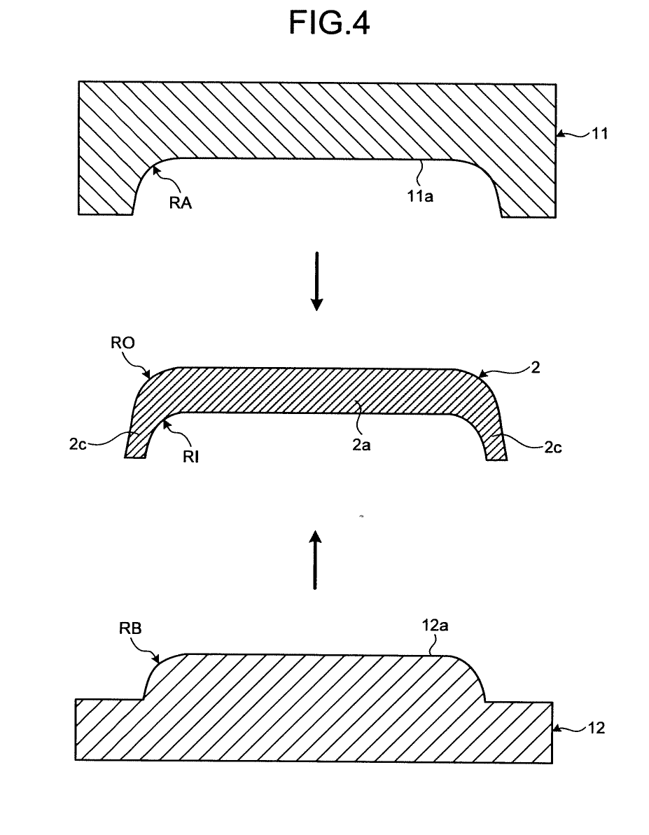

FIG. 3 is a diagram illustrating the brief of the compression process and the substantial configuration of a metal mold used at the compression process. FIG. 4 is an A-A line cross-sectional view of FIG. 3. As illustrated in FIGS. 3 and 4, the blank piece 2 is sandwiched by a pair of concave metal mold 11 and convex metal mold 12 and a predetermined compressive force is applied thereto.

In the case of the compression process, as illustrated in FIG. 4, the concave metal mold 11 that applies a compressive force to the blank piece 2 from the upper side of the blank piece 2 includes a concave portion 11a that has a smooth surface that comes into contact with a protruding outer surface of the blank piece 2. Assuming that a curvature radius of a surface that curves from the main plate portion 2a to the side plates 2c of the blank piece 2 and faces the concave metal mold 11 is RO and a curvature radius of a surface of the concave portion 11a that comes into contact with the surface of the blank piece 2 is RA, the two curvature radii RO and RA satisfy a relationship of “RO>RA”.

On the other hand, in the case of the compression process, as illustrated in FIG. 4, the convex metal mold 12 that applies a compressive force to the blank piece 2 from the lower side of the blank piece 2 includes a convex portion 12a that has a smooth surface that comes into contact with a recessed inner surface of the blank piece 2. Assuming that a curvature radius of a surface that curves from the main plate portion 2a to the side plates 2c of the blank piece 2 and faces the convex metal mold 12 is RI and a curvature radius of a surface of the convex portion 12a that comes into contact with the surface of the blank piece 2 is RB, the two curvature radii RI and RB satisfy a relationship of “RI>RB”.

FIG. 5 is a diagram illustrating a state where the blank piece 2 is sandwiched by the concave metal mold 11 and the convex metal mold 12 to apply a predetermined compressive force thereto at the compression process and the deformation of the blank piece 2 is substantially completed. In the state illustrated in FIG. 5, the blank piece 2 is subject to a compressive force from the concave metal mold 11 and the convex metal mold 12 and thus is deformed in the shape substantially like a bowl different from the shape before the softening process. “The shape substantially like a bowl” is a shape corresponding to a gap that is formed when the concave metal mold 11 and the convex metal mold 12 are closed. The shape substantially resembles the final shape that is obtained through a fixing process (Step S6) to be described below.

After the compression process is completed, a three-dimensional shape of the blank piece 2 is fixed (Step S4). To fix the three-dimensional shape, the blank piece 2 is sandwiched by the concave metal mold 11 and the convex metal mold 12. In a state where the predetermined three-dimensional shape is maintained, a water-vapor atmosphere having much higher temperature and pressure than the water-vapor atmosphere described above is formed around the concave metal mold 11 and the convex metal mold 12. In the higher water-vapor atmosphere, a pressure is around 0.6 to 3.4 MPa and a temperature is around 160 to 240° C. When the shape fixing process is performed in the pressure vessel, it is only necessary that the pressure of the vessel at the softening process has a value within the range described above.

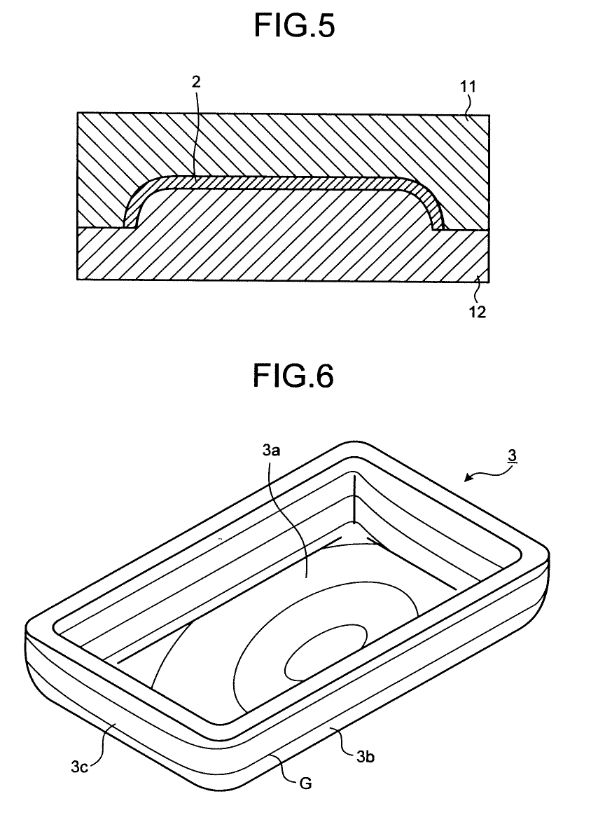

Next, the concave metal mold 11 and the convex metal mold 12 are released to expose the blank piece 2 into the atmospheric air and dry the blank piece 2 (Step S5). FIG. 6 is a perspective diagram illustrating a blank piece (hereinafter, “blank piece 3”) on which a drying process has been completed. It is preferable that the wall thickness of a main plate portion 3a of the blank piece 3 after the drying process be around 20 to 50% of the thickness of the main plate portion 2a of the blank piece 2 before the compression process.

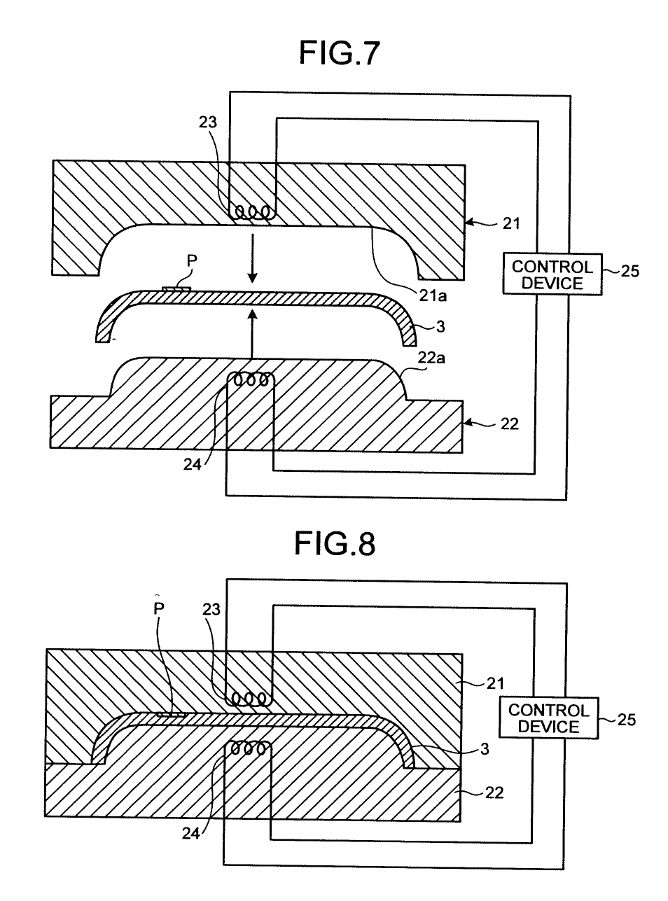

After the drying process, paper as an attachment is firmly fixed onto the surface of the blank piece 3 by applying a pressure to it while heating it in the atmospheric air (Step S6). FIG. 7 is a cross-sectional view typically illustrating the brief of the fixing process. At the fixing process, paper P is placed at a desired position on the surface of the blank piece 3, and then both the paper P and the blank piece 3 are sandwiched by a pair of heating concave metal mold 21 and heating convex metal mold 22. As a result, the paper P and the blank piece 3 is applied with a pressure while being heated in the atmospheric air so as to be firmly fixed on a desired position on the surface of the blank piece 3. The term “paper” means the thing obtained by intertwining fibers such as plant fibers with each other to form the shape of a thin film and drying it.

In this case, the paper P contains a vegetable fiber as the main component. On the paper P, characters that display a brand name, a material name, and the like, marks such as a logo mark, patterns, or desired patterns consisting of their combinations are previously drawn. Moreover, the attachment, including the paper P, gives new unprecedented texture and appearance to a compressed wood product that employs the blank piece 3 by forming a desired pattern at a desired position on the surface of the blank piece 3. For this reason, the desired pattern is not limited to the patterns and the like. In this case, a main component of the paper P means a material that is included in the paper P most highly.

At this time, as illustrated in FIG. 7, the heating concave metal mold 21 that is placed on the upper side of the blank piece 3 includes a concave portion 21a that has a smooth surface that comes into contact with the surface of the protruding side of the blank piece 3. Moreover, the heating convex metal mold 22 that is placed on the lower side of the blank piece 3 includes a convex portion 22a that has a smooth surface that comes into contact with the surface of the recessed side of the blank piece 3.

As illustrated in FIG. 7, heaters 23 and 24 are respectively provided in the heating concave metal mold 21 and the heating convex metal mold 22. The heaters 23 and 24 are connected to a control device 25 that has a temperature control function, and are activated to generate heat under the control of the control device 25. At the fixing process, a pressure is applied to the blank piece 3 by the heating concave metal mold 21 while heating the paper P, and thus the paper P is firmly fixed on the surface of the blank piece 3 with high adhesion. At this time, the control device 25 controls a temperature of metal molds when the blank piece 3 is sandwiched therebetween in such a manner that the temperature is not less than a temperature at which a non-crystallized region of a woody part is crystallized and is not more than a thermal decomposition temperature of the woody part. Specifically, the temperature of the heating concave metal mold 21 and the heating convex metal mold 22 is varied depending on materials of the attachment that is firmly fixed on the surface of the blank piece 3. The temperature is preferably in 160 to 240° C., is more preferably in 170 to 220° C., and is most preferably in 180 to 200° C.

FIG. 8 is a cross-sectional view typically illustrating a state where the pair of heating concave metal mold and heating convex metal mold is fastened at the fixing process in the method according to the embodiment. At the fixing process, the heating concave metal mold 21 and the heating convex metal mold 22 are fastened as illustrated in FIG. 8, and applies a pressure to the paper P and the blank piece 3 while heating the heating concave metal mold 21 and the heating convex metal mold 22 to a predetermined temperature in the atmospheric air by the heaters 23 and 24 that generate heat under the control of the control device 25. As a result of the heating and pressurization in the atmospheric air, the paper P is firmly fixed on the blank piece 3 with high adhesion by tree sap exuded from the woody part of the blank piece 3.

Moreover, because the crystallization of the woody part advances by the heating performed by the heating concave metal mold 21 and the heating convex metal mold 22 and thus the density of the woody part becomes much higher in the blank piece 3, the surface hardness of the woody part increases. As a result, a compressed wood product that is not subject to moisture absorption and is excellent in morphological stability can be achieved. Moreover, an adhesive may be secondarily used to firmly fix the paper P to the blank piece 3.

Furthermore, liquid material included inside a cell wall of the woody part is extracted to the surface of the blank piece 3 by heating the blank piece 3 in the atmospheric air. For this reason, the blank piece 3 after the fixing process is completed has color and luster caused by the liquid material on its surface and thus brings about an unprecedented new texture in combination with the firmly-fixed paper P.

In this way, because the heating concave metal mold 21 applies a pressure to the paper P in the atmospheric air while heating the paper P at the fixing process, the three-dimensional shape of the blank piece 3 receives only a small change compared to the compression process at which compression is performed on the blank piece 2 in the water-vapor atmosphere having high temperature and pressure, and thus the paper P that forms a desired pattern is firmly fixed without changing its shape at a desired position of the blank piece 3. For this reason, according to the method of the present invention, a desired pattern can be easily formed at a desired position of a compressed wood product when processing a wooden piece into a three-dimensional shape including a curved surface through compression.

FIG. 9 is a cross-sectional view illustrating a state where the paper P is firmly fixed to the blank piece 3 and then the blank piece 3 is cut at the position of the paper P. In FIG. 9, the surface of the paper P is in plane with its surrounding surface of the blank piece 3. This reason is that vegetable fibers that are the main component of the paper P assimilate into a wood component of the blank piece 3 and also are permeated into its surface to be firmly fixed with high adhesion by pressurizing them while heating them. As a result, even when a compressed wood product that employs the blank piece 3 to which the paper P is firmly fixed is recycled or is discarded, the contamination of an ecosystem can be avoided because the paper P and the blank piece 3 are naturally decomposed and are absorbed into soil. Moreover, when the paper P on which characters and symbols such as the name of a manufacturing plant and the date of manufacture are described is used for product management, the paper may be firmly fixed to the rear face of the main plate portion 3a and side plate portions 3b and 3c or the portion ranging over these portions instead of the front face of the blank piece 3.

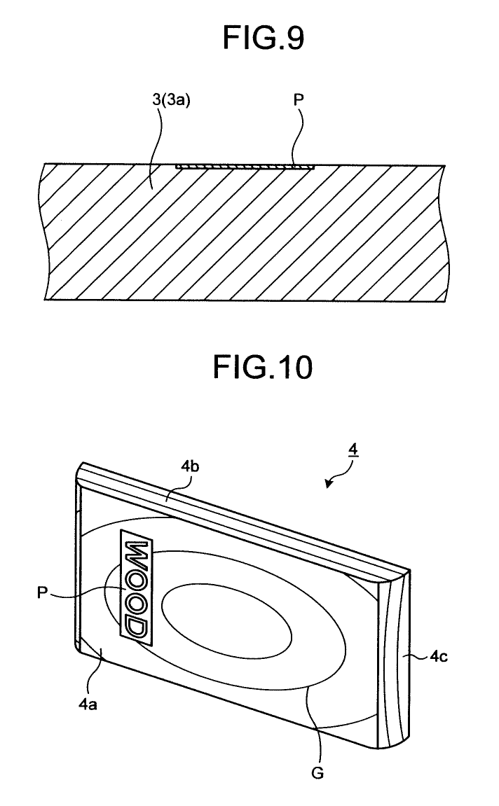

FIG. 10 is a perspective diagram illustrating a compressed wood product 4 that is manufactured as described above. The compressed wood product 4 illustrated in FIG. 10 includes a main plate portion 4a and side plate portions 4b and 4c that respectively correspond to the main plate portion 3a and the side plate portions 3b and 3c of the blank piece 3. The paper P is firmly fixed on one side near the side plate portion 4c of the main plate portion 4a.

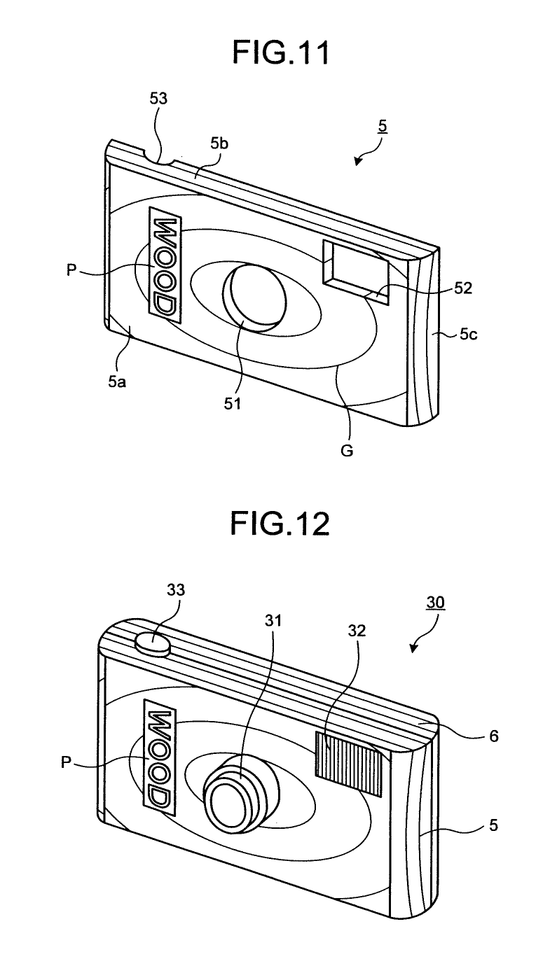

FIG. 11 is a perspective diagram illustrating an exterior body 5 of a digital camera as an example of application of the compressed wood product manufactured by the method of manufacturing a compressed wood product as described above. The exterior body 5 illustrated in FIG. 11 is a component with which the front side (the side facing a subject) of the digital camera is covered. The exterior body 5 includes a main plate portion 5a and side plate portions 5b and 5c that respectively correspond to the main plate portion 4a and the side plate portions 4b and 4c of the compressed wood product 4. The main plate portion 5a includes a cylindrical opening 51 from which an imaging unit of the digital camera is exposed and a rectangular opening 52 from which a flash of the digital camera is exposed. Moreover, the side plate portion 5b has a semi-cylindrical notch 53 from which a shutter button is protruded.

FIG. 12 is a perspective diagram illustrating a digital camera 30 of which the front side is covered with the exterior body 5. The digital camera 30 illustrated in FIG. 12 includes an imaging unit 31, a flash 32, and a shutter button 33. The front side of the digital camera 30 from which the imaging unit 31 and the flash 32 are exposed is covered with the exterior body 5. On the other hand, the rear side of the digital camera 30 is covered with an exterior body 6 that is formed of the compressed wood product 4 similarly to the exterior body 5. In this way, when the compressed wood product manufactured by the method of manufacturing a compressed wood product according to the present embodiment is applied as an exterior body of a digital camera, it is preferable that its wall thickness be around 1.0 to 1.6 mm.

According to the method of manufacturing a compressed wood product according to the embodiment described above, an attachment is firmly fixed to a wooden piece at the fixing process at which the change of a three-dimensional shape of wooden piece is small to be stable instead of at the compression process at which the change of the three-dimensional shape is large. Therefore, a desired pattern can be easily formed at a desired position of the compressed wood product without using a special device.

In the embodiment, the case has been described where the paper P is firmly fixed on the surface of the blank piece 3 as an attachment. However, if a desired pattern can be formed at a desired position of a compressed wood product, the attachment is not limited to paper. For example, the attachment may be metal foil such as gold foil and silver foil, metal powder such as gold powder and silver powder, burned ceramics or ceramic powder, or various types of ornaments such as a bead and a star-shaped sheet. Moreover, as an attachment, tree sap gathered from the same wooden piece may be applied on the blank piece after the compression process, coating material such as paints may be directly applied by using a paint brush, coating material such as paints may be applied with gradations by using an atomizer, or a branding iron may be performed on the surface of the wooden piece.

At this time, an attachment is firmly fixed to a wooden piece at the fixing process by applying a pressure to the attachment while heating the attachment in the atmospheric air after the compression process at which compression is performed in a water-vapor atmosphere having high temperature and pressure is completed. Therefore, because coating material is not flowed by water vapor when using coating material such as paints, a pattern shape can be firmly fixed to a wooden piece.

Moreover, the heating concave metal mold 21 and the heating convex metal mold 22 may be continuously used in the method of manufacturing a compressed wood product according to the embodiment described above by controlling a temperature by using the heaters 23 and 24 under the control of the control device 25. By doing so, it is not necessary to use the pair of the concave metal mold 11 and the convex metal mold 12. In this case, the fixing process is performed in a state where a pressure vessel is opened in the atmospheric air.

Furthermore, in the embodiment, the heating concave metal mold 21 and the heating convex metal mold 22 are heated by the heaters 23 and 24 in the atmospheric air and sandwich the blank piece 3 therebetween to firmly fix the paper P to the blank piece 3. However, if the blank piece 3 and the attachment including the paper P can be heated and pressurized at the temperature in the atmospheric air, the heating concave metal mold 21 and the heating convex metal mold 22 may not be used.

Moreover, the compressed wood product manufactured by the method of manufacturing a compressed wood product according to the present invention can be applied to an exterior body for electronics other than a digital camera described above, tableware, various cases, building material, and the like.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of manufacturing a compressed wood product, the method comprising:
applying a compressive force to a wooden piece in a water-vapor atmosphere having temperature and pressure higher than those of atmospheric air to deform the wooden piece into a three-dimensional shape having a curved surface;
placing an attachment for forming a pattern at a desired position on a surface of the wooden piece after applying the compressive force; and
applying a pressure to the attachment and the wooden piece while heating the attachment and the wooden piece in the atmospheric air to shape the wooden piece into substantially the same shape as the three-dimensional shape and to firmly fix the attachment to the wooden piece.

2. The method according to claim 1, wherein at the applying of the pressure, the wooden piece and the attachment are sandwiched between heatable metal molds.

3. The method according to claim 1, wherein the attachment contains a vegetable fiber as a main component.

4. The method according to claim 3, wherein at the applying of the pressure, the wooden piece and the attachment are sandwiched between heatable metal molds.

5. The method according to claim 3, wherein the attachment is paper.

6. The method according to claim 5, wherein at the applying of the pressure, the wooden piece and the attachment are sandwiched between heatable metal molds.
